(19) United States
(12) Patent Application Publication
(10) Pub. No.: US 2012/0095618 A1
(43) Pub. Date: Apr. 19, 2012

(54) AUTOMOTIVE ACTIVE REMOTE ENCRYPTION AND SWITCHING DEVICE

(75) Inventors: CHUN LO, TAINAN COUNTY (TW); CHIN-TIEN LIN, TAINAN CITY (TW); SHIH-JUNG LIN, TAINAN CITY (TW); CHUN-HSIEN WU, TAINAN CITY (TW); CHENG-HSIN WU, TAINAN CITY (TW)

(73) Assignee: DA AR FA INTERNATIONAL CO., LTD., TAINAN CITY (TW)

(21) Appl. No.: 12/905,222

(22) Filed: Oct. 15, 2010

(51) Int. Cl. G06F 7/00; H04M 1/00; H04N 7/167

(52) U.S. Cl. 701/2; 725/31; 455/556.1

(57) ABSTRACT

An automotive active remote encryption and switching device is revealed. Remote images and information are transmitted through wireless communication for monitoring vehicle status. The device includes at least one video mobile phone with specific permission, a control mainframe for receiving signals from the video mobile phone, a remote video recorder mounted in a vehicle, a detection unit that detects conditions inside the vehicle and a receiver that receives signals from the control mainframe. Thereby the remote images showing conditions in the vehicle are detected by the detection unit and sent to users by wireless communication equipments available now. Thus users can carry out corresponding measures and the active remote control of the vehicle is achieved by the video mobile phone.

### BACKGROUND OF THE INVENTION

1. Field of the Invention

The present invention relates to an active remote encryption and switching device, especially to an automotive active remote encryption and switching device that uses video mobile phones to transmit signals through wireless communication equipments for control of switches in vehicles and vehicle security.

2. Description of Related Art

Having a car stolen is absolutely a nightmare for people who love vehicles. Thus most of cars are equipped with anti-theft devices. However, vehicles are stolen more frequently in a shorter period due to renewed attack on vehicles.

According to satellite technology and network transmission available now, a plurality of anti-theft systems such as intelligent anti-theft system, global positioning system (GPS), etc has been developed now. When a car was stolen, GPS is used to estimate the position of the stolen car so as to get the track of the car. This is quite different from conventional anti-theft alarm with a buzzer. Although the GPS system can trace the vehicle position, it informs the user passively and can't talk to the intruder, record images or remote control the vehicle.

### SUMMARY OF THE INVENTION

Therefore it is a primary object of the present invention to provide an automotive active remote encryption and switching device in which remote images and information are sent back to users through wireless communication for monitoring vehicle status and controlling the vehicle. Thus users can take corresponding measures by video mobile phones that control vehicles at the remote end. Moreover, by the wireless communication function of the video mobile phone in combination with the telecommunications systems, trilateration that determines the relative position of vehicles and vehicle tracking are achieved.

In order to achieve the above object, the automotive active remote encryption and switching device consists of at least one video mobile phone with specific permission, a control mainframe for receiving signals from the video mobile phone, a remote video recorder mounted in the vehicle, a detection unit that detects conditions inside the vehicle and a receiver that receives signals from the control mainframe.

Moreover, the signal receiving interface has encryption settings and corresponds to at least one video mobile phone with permission. Thus there can be several mobile phones, each used by one family member. The video mobile phone is a wireless mobile phone that supports at least 3^{rd} generation (3G) of standards for mobile telecommunications and mobile phones services.

Furthermore, the detection unit can be a horizontal detector with a gyroscope, a pressure sensor, an infrared sensor, a smoke detector, etc. Different detectors are used to adapt various conditions in the vehicle.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing showing structure of an embodiment according to the present invention;

FIG. 2 is a schematic drawing showing an embodiment of a detection unit according to the present invention;

FIG. 3 is a schematic drawing showing an embodiment of the present invention in use.

### DETAILED DESCRIPTION OF THE PREFERRED EMBODIMENT

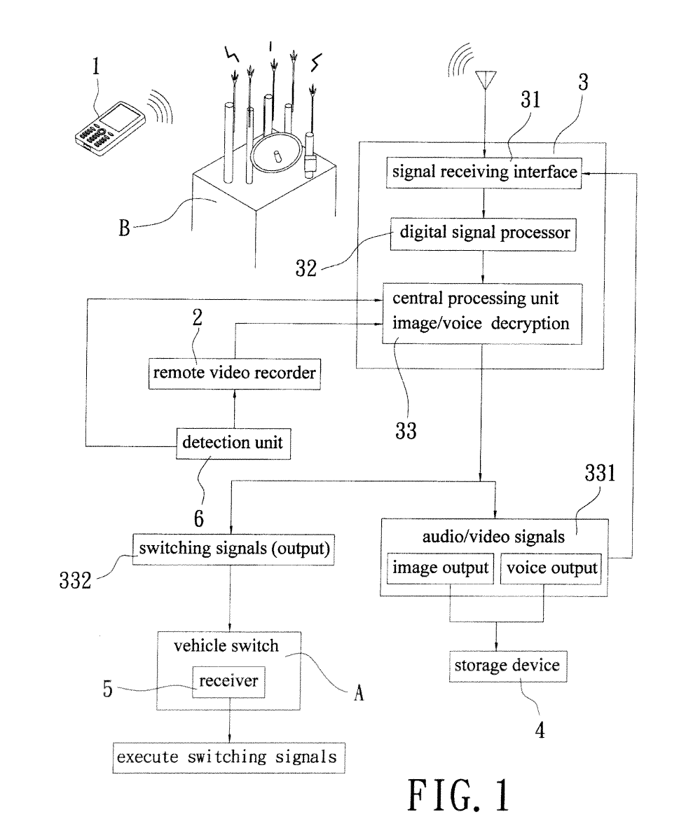

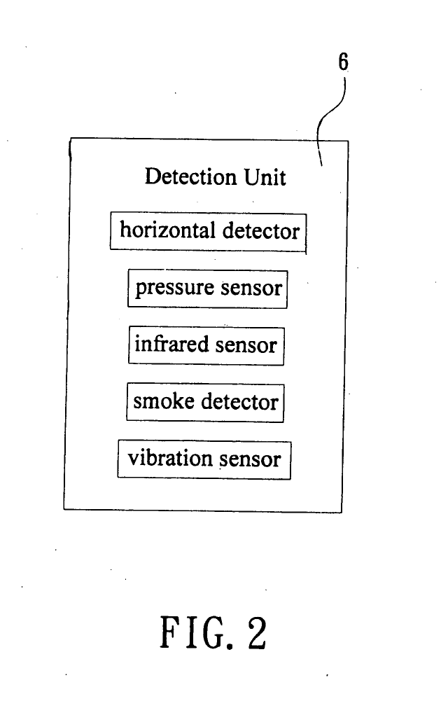

Refer to FIG. 1 and FIG. 2, an automotive active remote encryption and switching device that sends remote images and information back as well as controls on/off of at least one remote vehicle switch (A) includes at least one video mobile phone 1, a remote video recorder 2, a control mainframe 3, a storage device 4, a receiver 5 and a detection unit 6.

The video mobile phone 1 is a specific video mobile phone 1 that supports 3G standards, and sends or receives encrypted signals by a wireless telecommunications system (B). The remote video recorder 2 is an image recording unit for video recording and monitoring conditions in vehicles. The control mainframe 3 is a remote receiver for sending or receiving the encrypted signals from the video mobile phone by the wireless telecommunications system as well as decrypting and modulating the encrypted signals received to generate audio/video signals 331 and switching signals 332. The control mainframe 3 consists of a signal receiving interface 31, a digital signal processor 32, and a central processing unit 33. The signal receiving interface 31 is a remote receiver for sending or receiving the encrypted signals from the video mobile phone 1 by the wireless telecommunications system (B). The digital signal processor 32 is a processor that decrypts and modulates the encrypted signals received by the signal receiving interface 31. The central processing unit 33 receives images from the remote video recorder 2 and decrypted signals from the digital signal processor 32, and then outputs audio/video signals 331 as well as switching signals 332. The audio/video signals 331 are sent to the signal receiving interface 31 for being transmitted to the specific video mobile phone 1 and stored. As to the switching signals 332, they are sent to the vehicle switch (A). The storage device 4 receives the audio/video signals 331 from the central processing unit 33 of the control mainframe 3 and stores the audio/video signals 331. The receiver 5 is arranged at the vehicle switch (A) and is used for receiving the switching signals 332 from the central processing unit 33 of the control mainframe 3 so as to make the vehicle switch (A) execute the switching signals 332. The detection unit 6 is used for detecting conditions in the vehicle and sending sensing signals to the remote video recorder 2 and to the central processing unit 33 of the control mainframe 3 so that the sensing signals together with images from the remote video recorder 2 are sent to the central processing unit 33 of the control mainframe 3.

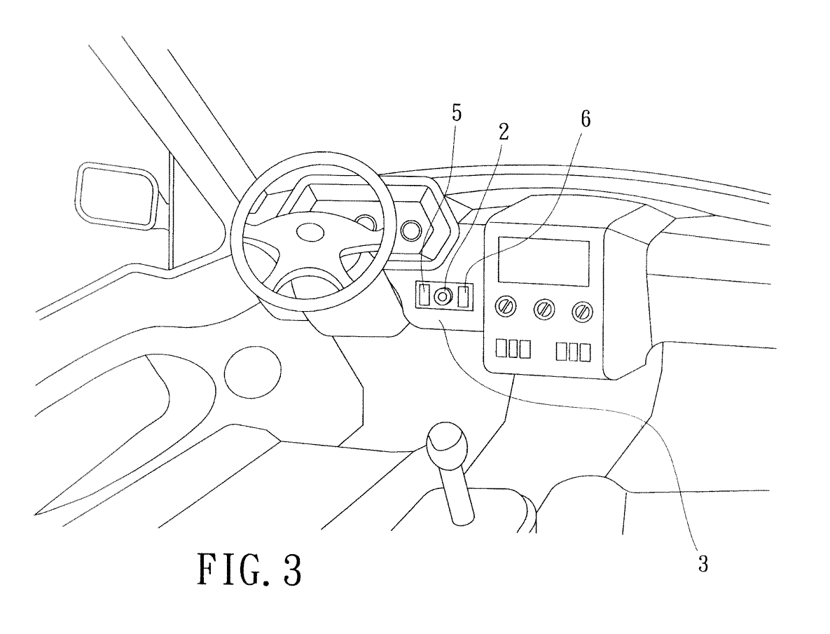

Refer to FIG. 2 and FIG. 3, the control mainframe 3 disposed in the vehicle gives specific permission to the users' video mobile phone 1 and has encryption settings at the same time. One control mainframe 3 is able to correspond to at least one video mobile phone 1 with permission.

When the vehicle is parked on a road and the driver forgot to lock the door, the driver can send a command through the specific video mobile phone 1 with permission to the signal receiving interface 31 of the control mainframe 3 by wireless communication. At the same time, input a password for the encryption so as to allow the signal receiving interface 31 receiving the signal of the command. The encrypted signal received by the signal receiving interface 31 is decrypted and modulated by the digital signal processor 32. The decrypted signal is sent to the central processing unit 33 that outputs at least one audio/video signal 331 and at least one switching signal 332 according to the decrypted signal received. The switching signal 332 is sent to the receiver 5 mounted in a central locking switch that controls the door locks. The receiver 5 executes the switching signal to turn on the central locking switch for door lock. Moreover, the communication between the video mobile phone 1 and the control mainframe 3, and images/voices (audio/video signals 331) from the remote video recorder 2 to the specific mobile phone 1 are all through the wireless communication. By the storage device 4 of the video mobile phone 1, the audio/video signals 331 are stored or are further sent to a cloud storage platform 4 of telecommunications service providers for storage. Furthermore, the video mobile phone 1 corresponding to the signal receiving interface 31 can send messages in a single time, multiple times or continuingly so as to control and operate a plurality of vehicle switches (A) in the car.

In another embodiment, when the vehicle is parked on a road and someone gets into the car by picking the lock on the car door, the detection unit 6 of the vehicle switch (A) detects signals from the surrounding environment. For example, the detection unit 6 can be a horizontal detector with a gyroscope or a vibration sensor that detects shaking of the car. The shaking represents an intrusion or unintentional contact. Or the detection unit 6 is a pressure sensor that detects pressure changes in the car due to intrusion, bump or other reasons. Or the detection unit 6 is an infrared sensor with an inducing circuit that is activated when the circuit is blocked by objects on the driver's or passenger's seat. This represents the intrusion and an anti-theft alarm is sent. Or the detection unit 6 is a smoke detector that is activated by fires caused by overheat in the car or other reasons. Different detectors are used to adapt various conditions in the vehicle. The detection unit 6 can be a single detector or a combination of several detectors. After receiving the signal, the sensing signals together with the images from the remote video recorder 2 are sent to the central processing unit 33 for decryption. The audio/video signals 331 are transmitted to user's video mobile phone 1 by the wireless telecommunications system (B). According to the audio/video signals 331 received, the user can monitor the person broken into the car and use the video mobile phone 1 to execute the instructions. The video mobile phone 1 with specific permission connects to the signal receiving interface 31 of the control mainframe 3 by the wireless communication. A password for the encryption is input at the same time so that the signal receiving interface 31 is allowed to receive the message. The encrypted signal received by the signal receiving interface 31 is decrypted and modulated by the digital signal processor 32. Next the decrypted signal is sent to the central processing unit 33 for audio/video signal 331 output and switching signal 332 output. The switching signal 332 is sent to be received and executed by the receiver 5 of the vehicle switch (A) to lock the car door, turn off the power for door lock, or make a buzzing alarm to prevent burglars getting into the car and call the police, etc. Later the recorded images (audio/video signals 331) are sent to the specific video mobile phone 1 by wireless communication and are stored in the storage device 4 of the video mobile phone 1, or are further sent to a cloud storage service 4 provided by telecommunications service providers for storage.

Compared with techniques available now, the present invention has following advantages
1. The device of the present invention sends signals and executes commands by wireless communication so that the signals can be transmitted in the place where the mobile phone can receive signals. There is no need to use wired transmission media such as wires or cables that have bandwidth problems. Thus the construction cost of the telecom systems is effectively reduced.
2. The vehicle switches for anti-theft and security mounted in the vehicle are controlled through remote wireless communication so as to protect vehicles from being stolen.
3. By the connection between the user's video mobile phone and the vehicle switches in the car (one is active and the other is passive) and wireless telecommunications that allow the signal receiving interface sending and receiving interactive signals, the commands are executed in an active way and related information is transmitted to the user actively.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An automotive active remote encryption and switching device that sends remote images and information back as well as controls on/off of at least one remote vehicle switch in a vehicle by wireless communication comprising:
at least one video mobile phone that is a specific video mobile phone sending or receiving encrypted signals by a wireless telecommunications system;
a remote video recorder that is an image recording unit for video recording and monitoring conditions in the vehicle;
a control mainframe that is a remote receiver for sending or receiving the encrypted signals from the video mobile phone by the wireless telecommunications system as well as decrypting and modulating the encrypted signals received to generate audio/video signals and switching signals;
a storage device that receives the audio/video signals from a central processing unit of the control mainframe and stores the audio/video signals;
a receiver that is arranged at the vehicle switch and is used for receiving the switching signals from the central processing unit of the control mainframe to make the vehicle switch execute the switching signals; and
a detection unit for detecting conditions in the vehicle and sending sensing signals to both the remote video recorder and the central processing unit of the control mainframe so that the sensing signals together with images from the remote video recorder are sent to the central processing unit of the control mainframe.

2. The device as claimed in claim 1, wherein the control mainframe includes:
a signal receiving interface that is a remote receiver for sending or receiving the encrypted signals from the video mobile phone by the wireless telecommunications system;
a digital signal processor that is a processor for decrypting and modulating the encrypted signals received by the signal receiving interface; and
a central processing unit that receives images from the remote video recorder and decrypted signals from the digital signal processor, output the audio/video signals to be stored and to the signal receiving interface for being further sent to the specific video mobile phone, and output the switching signals to the vehicle switch.

3. The device as claimed in claim 1, wherein the detection unit is a horizontal detector with a gyroscope, a vibration sensor, a pressure sensor, an infrared sensor, or a smoke detector.

4. The device as claimed in claim 1, wherein the detection unit includes two of the following: a horizontal detector with a gyroscope, a vibration sensor, a pressure sensor, an infrared sensor, and a smoke detector.

5. The device as claimed in claim 1, wherein the detection unit includes three of the following: a horizontal detector with a gyroscope, a vibration sensor, a pressure sensor, an infrared sensor, and a smoke detector.

6. The device as claimed in claim 1, wherein the detection unit includes four of the following: a horizontal detector with a gyroscope, a vibration sensor, a pressure sensor, an infrared sensor, and a smoke detector.

7. The device as claimed in claim 1, wherein the detection unit includes a horizontal detector with a gyroscope, a vibration sensor, a pressure sensor, an infrared sensor, and a smoke detector.

8. The device as claimed in claim 1, wherein the video mobile phone supports at least 3^{rd} generation of standards for mobile telecommunications and mobile phones services.

9. The device as claimed in claim 1, wherein the storage device is a memory storage device of the video mobile phone.

10. The device as claimed in claim 1, wherein the storage device is a cloud storage platform of telecommunications systems.

11. The device as claimed in claim 2, wherein the detection unit is a horizontal detector with a gyroscope, a vibration sensor, a pressure sensor, an infrared sensor, or a smoke detector.

12. The device as claimed in claim 2, wherein the detection unit includes two of the following: a horizontal detector with a gyroscope, a vibration sensor, a pressure sensor, an infrared sensor, and a smoke detector.

13. The device as claimed in claim 2, wherein the detection unit includes three of the following: a horizontal detector with a gyroscope, a vibration sensor, a pressure sensor, an infrared sensor, and a smoke detector.

14. The device as claimed in claim 2, wherein the detection unit includes four of the following: a horizontal detector with a gyroscope, a vibration sensor, a pressure sensor, an infrared sensor, and a smoke detector.

15. The device as claimed in claim 2, wherein the detection unit includes a horizontal detector with a gyroscope, a vibration sensor, a pressure sensor, an infrared sensor, and a smoke detector.

16. The device as claimed in claim 2, wherein the video mobile phone supports at least 3^{rd} generation of standards for mobile telecommunications and mobile phones services.

17. The device as claimed in claim 2, wherein the storage device is a memory storage device of the video mobile phone.

18. The device as claimed in claim 2, wherein the storage device is a cloud storage platform of telecommunications systems.
